(19) United States
(12) Patent Application Publication
(10) Pub. No.: US 2025/0145429 A1
(43) Pub. Date: May 8, 2025

(54) CHAIN DRIVE ARRANGEMENT AND LIFTING EQUIPMENT WITH DOUBLE CHAIN WHEEL

(71) Applicant: pewag austria GmbH, Kapfenberg (AT)

(72) Inventor: Äygd Pengg, Klagenfurt (AT)

(73) Assignee: pewag austria GmbH, Kapfenberg (AT)

(21) Appl. No.: 18/928,250

(22) Filed: Oct. 28, 2024

(30) Foreign Application Priority Data
Nov. 7, 2023 (EP) 23208259.4

(51) Int. Cl. B66D 3/16

(52) U.S. Cl. CPC B66D 3/16

(57) ABSTRACT

A lifting mechanism device having an electric or pneumatic motor and two link members has two chain wheels, which are arranged beside each other on a shaft, which is driven by the motor, wherein each chain wheel is used to guide in each case a portion of a link chain with alternately horizontal links and vertical links, that is to say, having pockets for receiving horizontal links and having a groove which extends in the circumferential direction for receiving vertical links. The chain wheels are arranged in a rotationally secure manner with respect to each other in an angular position in the same direction in which the angle pockets of the two chain wheels are located offset with respect to each other by only a distance parallel with the shaft, but are not rotated with respect to each other.

### BACKGROUND OF THE INVENTION

The invention relates to a lifting mechanism having a double chain wheel, wherein more than one link chain is used as the carrier means. In particular, the invention relates to a chain drive arrangement having a chain drive on a chain drive shaft which can be driven by a motor, wherein at least two link chain strands can be guided via the chain drive, and a lifting mechanism device in which such a lifting mechanism device is connected to a motor directly or in terms of transmission. The invention further relates to a lifting mechanism system which contains a lifting mechanism device and link chain strands which are guided via the chain drive of the lifting mechanism device and a stop apparatus which can be fitted to the ends of the link chain strands.

In lifting mechanisms (this term also includes chain drive arrangements, lifting mechanism devices and systems) of the type under consideration here, link chains—in particular industrial round steel chains or profile steel chains—are used as carrier means for the lifting and/or movement of loads. In this instance, the chain links of a chain strand are guided via a chain wheel (also referred to as a chain sprocket), wherein the links of the chain strand are orientated alternately on the outer face of the chain wheel vertically and horizontally. Advantageously, the chain drive has two chain wheels which are arranged beside each other on a shaft of the chain drive, wherein each of the chain wheels for guiding in each case a portion of a link chain strand is configured with alternately horizontal and vertical links, that is to say, with pockets for receiving horizontal links and with a groove which extends in a circumferential direction for receiving vertical links.

In lifting mechanism devices and stop apparatuses, the durability and reliability with respect to breakage of the chain is naturally of particular importance. If, for example, the load-bearing capacities of motor-operated or manually operated lifting gears are intended to be doubled, the chain drive arrangement in the lifting gears with one chain strand can be converted to a two-strand configuration of the link chain in accordance with the pulley principle, for example, with a redirection roller for redirecting the chain. Multiple strands can also be configured in order to triple or multiply the load-bearing capacity. However, it is disadvantageous in this instance that the chain under full load-bearing capacity also has to be guided over redirection wheels. With a double-strand chain drive arrangement, this leads to a tripling of the loaded angulations of the chain in each lifting cycle on the chain wheels involved (once on the drive chain wheel and twice on the redirection chain wheel). This leads to a significant reduction in the service-life of the chain, which is thereby practically divided by three. The lifting speed of the multi-strand chain drive arrangements is also reduced inversely with respect to the number of strands. The inventors have recognized the often considerable spatial requirement of the chain wheels as an additional disadvantage.

### BRIEF SUMMARY OF THE INVENTION

In order to overcome these disadvantages, it is proposed according to the invention that in a chain drive arrangement the chain drive have two or more chain wheels which are arranged beside each other in a rotationally secure manner on a shaft of the chain drive, wherein the two chain wheels are arranged in an angular position in the same direction with respect to each other. In this angular position in the same direction, the angle pockets of the two chain wheels are located offset with respect to each other by only a distance parallel with the shaft.

This solution according to the invention affords a plurality of advantages. As a result of the use of a double (or multiple) chain wheel and correspondingly multiplied chain, the load of the lifting mechanism (without additional chain angulations per chain) can also be doubled or multiplied and the negative effect on the chain service-life is avoided. The invention also enables the use of chains in which the chain links have relatively small strand cross sections, and chain wheels with a relatively small diameter. The possibilities for using a smaller chain (with the same load-bearing capacity per chain) is additionally advantageous with respect to the chain service-life. Small chain dimensions afford advantages with respect to the wear service-life compared with larger chains since with them the ratio of the chain surface to the chain volume improves.

With a chain drive having a double chain wheel, the diameter of the chain used can be reduced with the same load-bearing capacity by the factor √2 (this corresponds to two chains with half the load-bearing capacity). The required division of the chain and the size of the chain wheel is thereby reduced by the same factor. Consequently, with the same load-bearing capacity the double chain drive can be reduced with regard to the diameter by a factor of 1/√2=0.71 in comparison with a chain drive having a single chain.

As a result of this reduction of the chain wheel size, the drive torque required in the associated lifting mechanism can also be reduced by this factor. As a result, the chain drives in the lifting mechanism devices can on the whole be constructed to be smaller. As a further consequence, a smaller drive torque is required and consequently the weight of the chain drive with a double chain drive can also be reduced compared with a chain drive having an individual chain for the same load. The linear dimensions of the chain drive are thereby reduced by approximately 11% (according to the cube root of 0.71). As a result of the weight and size savings on the chain drive and on the whole of the lifting mechanisms, there are additionally considerable savings with respect to costs and material.

An additional advantage has been found to be an increase in the safety with respect to failure of a chain., in particular chain breakage, as a result of the use of two or more parallel running chains. Should a chain fail (break), the load nonetheless does not fall, the other chain can—for example, when configured with 4-fold safety—still carry the load.

In an advantageous further development of the invention, the lifting mechanism device is additionally provided with a motor which is connected to the chain drive shaft directly or in terms of transmission. Particularly for compact machine-operated lifting mechanisms which are used in lifting systems such as, for example, cranes, this affords specific advantages. In these lifting mechanisms and the systems in which they are installed, not only the more compact construction type is advantageous, but also the fact that additional components, such as the gear mechanism or brake device (safety brake) can be configured to be smaller since for a consistent load-bearing capacity the dimensions of a chain strand can be relied upon (instead of on the configuration of the chain hoist as a whole); consequently, the sizing of the motor and where applicable an associated gear mechanism and/or an associated brake device can correspond to the size of an individual link chain strand. This applies particularly when the motor is electrically or pneumatically operated.

In particular, the replacement of the (single) chain wheel with a double chain wheel allows, for the same load-bearing capacity of the compact lifting gear, the size of the chain (size of the chain links) and the chain wheel to be able to be configured to be smaller, and, as a result of the smaller diameter of the chain wheel, smaller torques are produced; this consequently enables reduced dimensions for the brake (safety brake), the motor gear mechanism and ultimately also the motor (with the same power, but at a higher speed). In addition, a smaller housing can also be provided and weight can on the whole be saved. On the whole, the invention leads in particular for motor-operated lifting mechanisms to considerable cost savings.

Advantageously, the chain wheels can be arranged directly beside each other on the shaft and preferably be configured in an integral manner and/or the chain wheels are spaced apart from each other on the shaft. A particularly advantageous configuration is produced with a chain drive having two chain wheels. These may be formed in a mirror-symmetrical manner with respect to each other.

In order to improve the guiding of the chains via the chain wheels, a housing which surrounds the chain wheels and which at the inner side limits the movement space of the chain links on the chain wheels in a radial direction is advantageous. In this instance, it may be advantageous for the housing to have at the inner side beside each other two grooves in which vertical links of the link chain strands which run on the chain wheels are guided.

The advantages mentioned particularly also result for a lifting mechanism system which in addition to a lifting mechanism device of the type mentioned above is provided with link chain strands which are guided via the chain drive of the lifting mechanism device and a stop apparatus which is fitted to the ends thereof and which has two connection locations which are arranged beside each other for one end member of each link chain strand and at a side facing away from the link chain strands a connection portion for a load, wherein the connection locations are arranged at the same height with respect to a load direction (that is to say, parallel with the extent direction of the link chain strands). Advantageously, the connection portion may comprise a load hook. This may be supported on the stop apparatus so as to be able to be rotated about an axis parallel with the load direction.

### BRIEF DESCRIPTION OF THE DRAWINGS

The invention together with additional details and preferences will be explained in greater detail below with reference to a number of exemplary embodiments which are illustrated in the drawings and which are all purely exemplary and do not limit the invention. In the schematic drawings:

FIG. 1A shows a lifting mechanism system having an electric motor according to a first exemplary embodiment of the invention as a side view (

FIG. 1b shows a front view of the lifting mechanism system of FIG. 1a;

FIG. 2 shows a lifting mechanism system having a conventional single chain wheel;

FIG. 3 shows a perspective view of a chain drive system having a double chain wheel and a stop apparatus which can be used in the lifting mechanism of FIG. 1a;

FIG. 4a shows the double chain wheel of FIG. 3 as a front view;

FIG. 4b shows a longitudinally sectioned view of the double chain wheel of FIG. 3;

FIG. 4c shows a sectioned view of a chain wheel along the center plane of FIG. 3;

FIG. 5a shows the chain drive system of FIG. 3 as a plan view;

FIG. 5b shows a front view of the chain drive system of FIG. 3;

FIG. 5c shows a side view of the chain drive system of FIG. 3;

FIG. 6a shows the chain drive of FIG. 4a together with a housing which surrounds the chain wheels, as a front view;

FIG. 6b shows a longitudinally sectioned view of the chain drive and housing of FIG. 6a;

FIG. 6c shows a sectioned view of the chain drive and housing of FIG. 6a along the center plane of one of the chain wheels;

FIG. 7a shows a lifting mechanism system having a pneumatic motor according to another exemplary embodiment of the invention as a side view; and

FIG. 7b shows a front view of the lifting mechanism system of FIG. 7a.

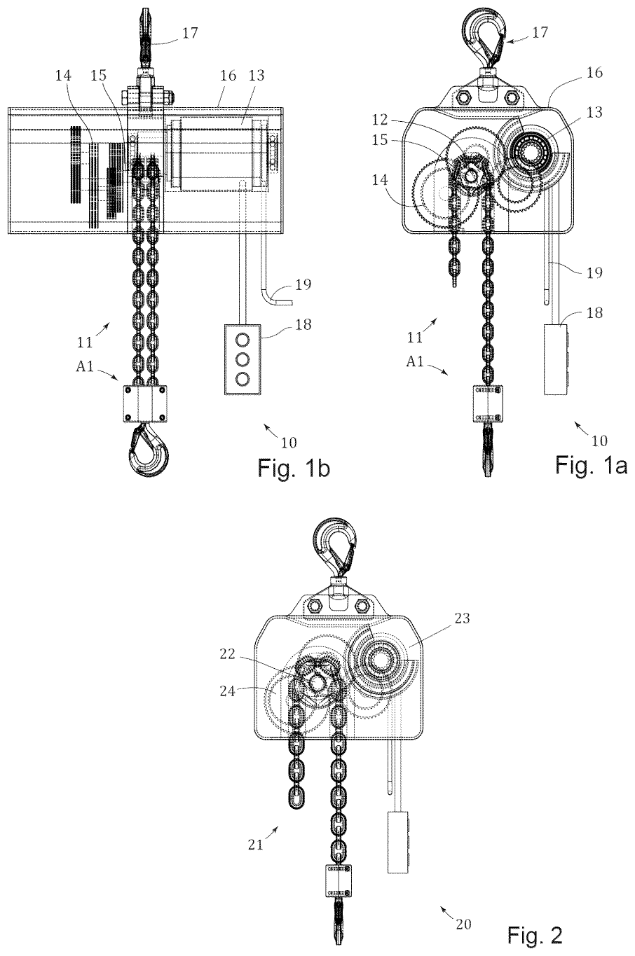

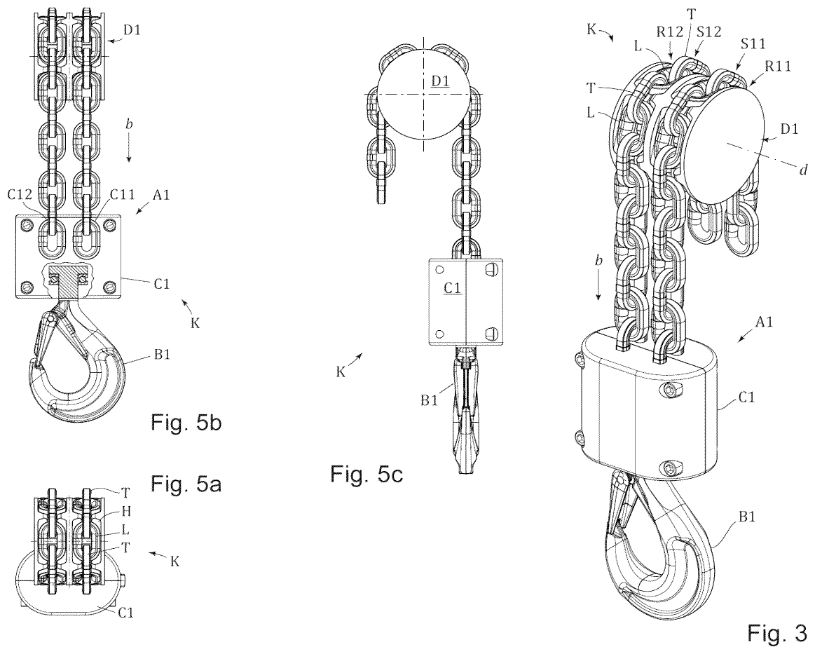

In the figures and for reasons of clarity, elements which are the same are provided with the same reference numerals. The reference numerals in the claims are intended simply for greater understanding and in no way represent a limitation on the respective embodiments. There are shown in the drawings exemplary embodiments in which—without this being intended to be interpreted as limiting for the invention—a load is carried against gravitational force, and consequently the load direction b then corresponds (see FIGS. 1 and 3) with the vertical; however, it is obvious that in other applications the load direction may also be orientated differently, as, for example, in the case of transport of the load along a track, wherein the load direction then generally corresponds to the extent direction of the path. Generally, the chains which are used in the chain hoist as load means extend in the loaded operating state substantially symmetrically in the load direction. Terms such as “upper region”, “lower” or “lower side” are intended to be understood in this context, that is to say, with respect to an orientation in accordance with a vertically notional load direction.

### DETAILED DESCRIPTION OF THE INVENTION

The exemplary embodiments set out below relate to chain drives which are configured for round steel chains in which the individual chain links are rotated with respect to each other through 90° about the extent direction of the chain. The chains may also be chain links of another form such as, for example, profile steel chains and the person skilled in the art can readily carry out the corresponding adaptations of the chain wheels according to the invention and chain drive systems for chains of these types. The chains are generally produced from steel, such as, for example, case hardening steel, but hardened and tempered steel may also advantageously be used.

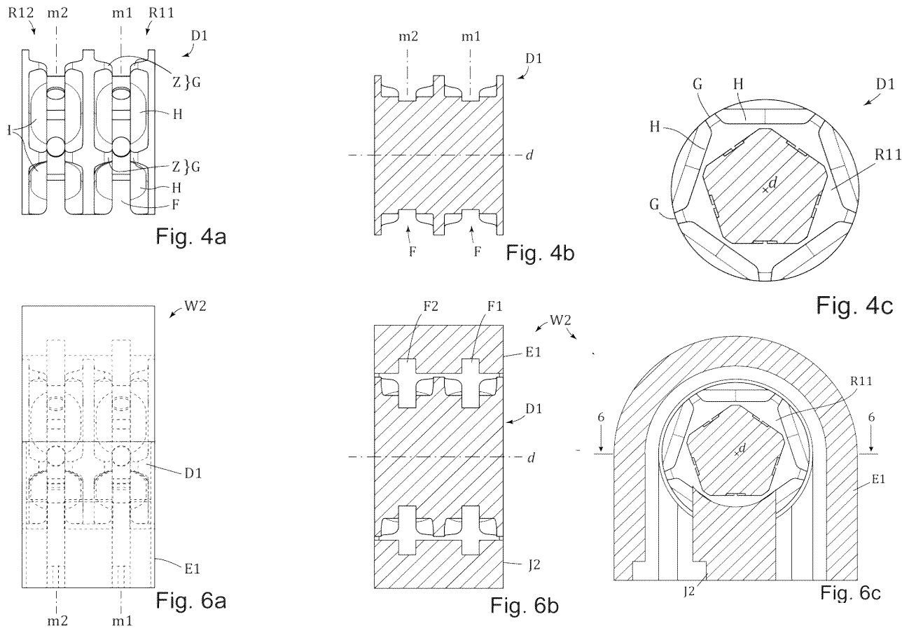

When a link chain is guided over a chain wheel of a chain drive according to the invention, the individual chain links are retained thereon and thus guided alternately vertically T and horizontally L (see, for example, FIGS. 3 and 4a) on the respective chain wheel. The terms “vertically” and “horizontally” have in this instance the meaning which is already conventional in the prior art. A vertical chain link T is a chain link which is supported with (only) one leg. The eye of a chain link which is vertical on the chain wheel is orientated substantially parallel with the rotation axis of the chain wheel. On a chain wheel this leg of the vertical chain member is often located in a groove, which extends in the circumferential direction and which determines the position of the chain link, of the chain wheel. A horizontal chain link L is a chain link, the two legs of which rest beside each other. The eye of a horizontal chain link on the chain wheel is orientated substantially radially with respect to the rotation axis of the chain wheel. In the chain wheels taken into consideration in this instance, there are generally provided chain pockets which in each case receive a horizontal chain link.

FIGS. 1a and 1b each shows a lifting mechanism system 10 according to a first embodiment of the invention. The lifting mechanism system contains a chain drive system having a double chain 11 and a double chain wheel 12 according to the invention, as discussed in detail below, and an electrically driven motor 13 which via a gear mechanism 14 drives the shaft 15 in order to drive the chain drive system 11, that is to say, the shaft on which the double chainwheel of the chain drive system 11 is arranged. A connection cable 19 serves to electrically supply the electric motor 13.

The motor 13, the gear mechanism 14 and the upper portion of the chain drive system 11 (in particular the double chain wheel 12) are accommodated in a housing 16 which at least in the region of the chain drive is open in a downward direction. The housing 16 may at the upper side thereof, for example, by means of an assembly hook 17, which is fixedly mounted at that location, be retained and positioned on a carrier (not shown) or crane boom or the like. The lifting mechanism system 10 and in particular the operation of the electric motor 13 are controlled and monitored in accordance with a manner known per se, for example, via a manual operating unit 18.

FIG. 3 is a perspective view of an embodiment of a chain drive system K which can be used in particular as a chain drive system 11 in the system of FIGS. 1a and 1b. The chain drive system K contains a chain drive in the form of a double chain wheel D1 together with two chain strands S11, S12 of a chain hoist which are guided thereon and at the ends of which a stop apparatus A1 is additionally secured. As can be seen in FIG. 3, the two chain strands S11, S12 are guided around one of the two chain wheels R11, R12 of the double chain wheel D1 in each case, wherein the individual chain members are retained and thus guided alternately vertically T and horizontally L on the respective chain wheel R11, R12.

In FIG. 2, for comparison, a lifting mechanism system 20 of conventional type with an individual chain 21 and a chain wheel 22 is illustrated. Since in this instance the load which is intended to be lifted is retained and moved by an individual chain, the chain 21 is sized to be correspondingly large; the sizing of the motor 23 and the gear 24 mechanism follow the sizing of the chain 21. In contrast, the two chains 11 of the lifting mechanism system 10 of FIGS. 1a and 1b can be configured to be smaller since in this instance the load which is intended to be lifted is distributed over two chain strands. This also permits a smaller configuration of the gear mechanism 14 and where applicable also the motor 13. There is therefore on the whole a reduction and more economical configuration of the lifting mechanism system 10, with a smaller spatial requirement—smaller housing 16—and smaller weight of the lifting mechanism in comparison with previous lifting mechanisms. Furthermore, as a result of the multiple configuration of the chain, there is increased reliability with respect to breakage of a chain strand as a result of the mutual redundancy of the chain strands.

For example, a chain drive with a double chain wheel in comparison with a conventional chain drive with a simple chain wheel could have a technical configuration as set out in Table 1:

TABLE 1

| | Single | Chain drive |
|---|---|---|
| | chain drive | with double |
| | (Prior art) | chain wheel |
| Chain size d × t [mm] | 10 × 30 | 7.1 × 21.3 |
| Load-bearing capacity of the chain [kg] | 2000 | 1000 |
| Chain wheel size, partial circle, z = 5 [mm] | 97.1 | 68.9 |
| Drive torque on the chain drive [%] * | 100 | 71 |
| Weight saving of the | 0 | 29 |
| chain drive system [%] * | | |
| Weight saving (linear dimension) [%] * | 0 | 11.0 |

* in comparison with single chain drive (Column 2/FIG. 2)

FIGS. 4a-4c each shows further details of the chain wheels of the chain drive (double chain wheel D1) of FIG. 3 without any chain links placed therein. In this instance, FIG. 4a shows a front view, FIG. 4b shows a longitudinally sectioned view along a plane of section through the rotation axis d of the chain drive, and FIG. 4c shows a sectioned view of a chain wheel R11 along the center plane m1 (viewing direction along the rotation axis d); this completely corresponds to a sectioned view of the other chain wheel R12 along the center plane m2.

In FIGS. 5a-5c, the chain drive system K is shown as three other views (FIG. 5a-5c), that is to say, as a plan view (FIG. 5a; viewing direction along the load direction b), a front view (FIG. 5b) and a side view (FIG. 5c; viewing direction parallel with the rotation axis d of the chain wheel). In FIGS. 3 to 5, the chain drive is shown without a housing so that the chain wheel and the chain strands which are guided therein can be better seen; the housing E1 is optional and is explained below with reference to FIGS. 6a-6c.

With reference to FIGS. 4a-4c, each of the chain wheels R11, R12 is in the form of a so-called pocket chain wheel. It accordingly has pockets H which are adapted to the oval link shape and which have a substantially planar support face (pocket base) for a horizontal chain link L in each case (cf. FIG. 5a). In the longitudinal center of the pockets, where applicable there may additionally be formed recesses which serve to receive a potential weld bead (not shown) around a leg of the chain link so that a horizontal chain link L even when such a weld bead is present can rest flat on the support face of the pocket H. The pockets of the chain wheel are delimited with respect to each other by means of webs G, wherein each web is divided by means of a groove F in order to receive the vertical links T in the center plane m1, m2 of the chain wheel R11, R12 so that a web G is divided into two teeth Z (in each case left and right of the center plane m1 or m2). In the present exemplary embodiment, the chain wheel has in the side view a pentagonal shaping (number of pockets z=5) with five pockets H and accordingly five webs G which delimit them with respect to each other; however, it is clear that a chain wheel may readily also have a larger or smaller number z of pockets and webs. The webs G have convex flanks which merge at the “inner” edge (that is to say, closest to the rotation axis d) directly into the planar support faces of the pockets H, preferably with a prominent transition edge. In the preferably planar base of the grooves F for the vertical legs T, there may additionally be formed between the teeth Z an indentation which serves the same purpose as the above-mentioned recess in the pocket base, that is to say, to receive a potential weld bead (not shown) of the vertical leg T so that it can rest or be supported with the planar outer side of the inner leg thereof on the groove base in a planar manner. This is because the support of the vertical links T on the groove base of the groove F is of great significance for the function of the chain drive or wheel since the horizontal links L during the pivoting-in operation are supported themselves on the vertical Ts, whereby a pivoting-in of the horizontal chain links on the respective pocket bases in the correct position is facilitated. As a result of this configuration of the chain wheel, both the horizontal links L and the vertical links T are supported in a planar manner, that is to say, the horizontal links L with a majority of the side faces thereof on the support face of the pockets and the vertical links T with the outer face of the inner leg on the groove base.

In the double chain wheel D1, the two chain wheels R11, R12 beside each other are connected to each other coaxially in a rotationally secure manner. According to the invention, the chain wheels are arranged with respect to each other without a relative angle offset, that is to say, the chain pockets of one chain wheel R11 are located directly beside the chain pockets of the other chain wheel R12, when viewed along the rotation axis d. In an equivalent manner, this can also refer to the webs G, that is to say, the webs G of one chain wheel R11 are located directly beside the webs G of the other chain wheel R12, when viewed in the direction along the rotation axis d. According to another aspect, the two chain wheels R11, R12 can also be considered to be configured symmetrically with respect to each other about the center plane m0. The two chain wheels are, for example, configured integrally in the double chain wheel D1, alternatively they may be in the form of individual components R11 and R12 which are connected in a rotationally secure manner to each other in an appropriate manner, for example, by means of connection pins or also by means of welding.

With reference again to FIGS. 1-3, the load (not shown) which is intended to be carried by the lifting mechanism is connected at the ends of the two chains S11, S12 using a stop apparatus A1 which in each case has a connection location for the chain strands, wherein these connection locations are arranged with respect to each other at the same height in the load direction. The stop apparatus A1 comprises a stop component C1 having a load hook B1. The stop component C1 is formed by a body which is configured in a socket-like manner and in the “upper” region of which connection locations C11, C12 are provided. By means of these connection locations C11, C12 which are provided inside the body, respective end members of the chain strands are placed and secured, for example, with a bolt (not shown).

The load hook B1 is in the “lower side” of the body of the stop component C1 preferably rotatably supported about an axis parallel with the load direction b. In a variant, however, the load hook B1 may be fitted in a rotationally secure manner to the body of the stop component C1.

Generally, the stop apparatus has at the side opposite the connection portion two (or where applicable more) connection locations which are arranged beside each other for an end member of each link chain, wherein these connection locations are preferably arranged at the same height when viewed in the load direction.

FIGS. 6a-6c each shows an example of a lifting mechanism arrangement W2 in which the double chain wheel D1 is rotatably supported in a chain drive housing E1 (the components for retaining the housing are omitted in FIGS. 6a-6c for the sake of clarity). In this instance, FIG. 6a shows a front view; FIG. 6b shows a longitudinal section along the “horizontal” plane of section 6-6 through the rotation axis d of the double chain wheel D1; and FIG. 6c shows a sectioned view along the center plane m1 of the chain wheel R11. The housing E1 surrounds the chain wheels R11, R12 and delimits internally the movement space of the link chains on the chain wheels in the radial direction. The double chain wheel D1 is concentrically supported by the shaft (which extends along the rotation axis d) and the retention members thereof (not shown) in the housing E1 so that the wheel D1 can rotate in the housing E1 without touching it, and at the same time is rotatably secured therein. As can be seen in particular in the sectioned illustration of FIG. 6b, the housing has at the inner side beside each other two grooves F1, F2 in which vertical links of the link chains which run on the chain wheels are guided. An inner portion J2, also referred to as a wiper, may additionally be provided and closes the chain drive at the output side and additionally can guide the chain portions when entering the chain drive and in particular during release (“discharge”) of the chains from the chain wheels and when leaving the chain drive. The housing E1 and the inner portion J2 are, for example, retained in the motor housing.

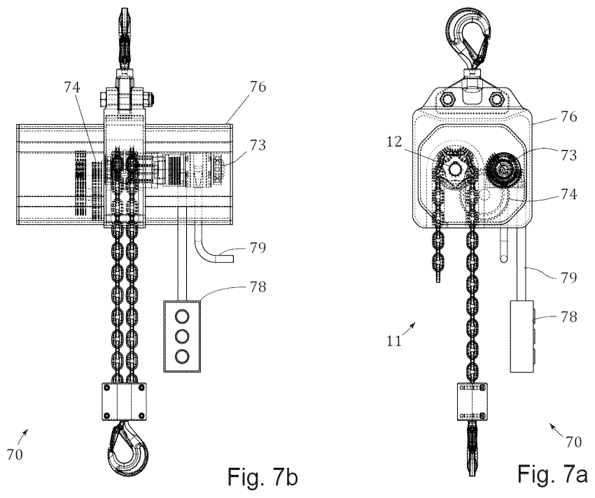

Another exemplary embodiment of the invention which is a pneumatically operated lifting mechanism system 70 is shown in FIGS. 7a and 7b. This lifting mechanism system 70 also contains a chain drive system with a double chain 11 and a double chain wheel 12 according to the invention, but a motor 73 which is driven with compressed air and which is, for example, controlled and monitored by a manual operating unit 78 and pneumatically supplied via a compressed air line 79. The pneumatic embodiment is characterized by additional space and weight savings of the motor 73 and gear mechanism 74 so that the housing 76 also becomes more compact. Furthermore, this embodiment corresponds to the embodiment explained above with reference to FIGS. 1a-1c and 3-6c.

Naturally, the person skilled in the art is capable of modifying the invention taking into consideration the illustrated embodiments and the description and adapting it to given requirements. The technical structure of the invention is therefore not limited to the illustrated embodiments; instead, the invention extends to the entire protective scope which is derived from the following claims.

1. A chain drive arrangement having a chain drive on a chain drive shaft which can be driven by a motor, wherein at least two link chain strands can be guided via the chain drive,
wherein the chain drive has at least two chain wheels which are arranged beside each other on a shaft of the chain drive, and of which each is configured to guide a portion of a link chain strand with alternately horizontal links and vertical links having pockets for receiving horizontal links and having a groove which extends in the circumferential direction for receiving vertical links,
wherein the two chain wheels are arranged in a rotationally secure manner with respect to each other in an angular position in the same direction in which the angle pockets of the two chain wheels are located offset with respect to each other by only a distance parallel with the shaft.

2. The chain drive arrangement according to claim 1, characterized in that the chain wheels are arranged directly beside each other on the shaft and are preferably configured in an integral manner.

3. The chain drive arrangement according to claim 1, characterized in that the chain wheels are spaced apart from each other on the shaft.

4. The chain drive arrangement according to claim 1, characterized in that the chain drive has two chain wheels which are configured in a mirror-symmetrical manner with respect to each other.

5. The chain drive arrangement according to claim 1, characterized by a housing which surrounds the chain wheels and which delimits at the inner side the movement space of the chain links on the chain wheels in the radial direction.

6. The chain drive arrangement according to claim 5, wherein the housing has at the inner side beside each other two grooves in which vertical links of the link chain strands which run on the chain wheels are guided.

7. A lifting mechanism device having a chain drive arrangement according to claim 1 and a motor which is connected to the chain drive shaft directly or in terms of transmission, wherein the motor is operated electrically or pneumatically.

8. The lifting mechanism device according to claim 7, wherein the sizing of the motor and where applicable an associated gear mechanism and/or an associated brake device corresponds to the size of an individual link chain strand.

9. A lifting mechanism system having a lifting mechanism device according to claim 7 and link chain strands which are guided via the chain drive of the lifting mechanism device and a stop apparatus which has for the securing of ends of the said link chain strands connection locations arranged beside each other for an end link of each link chain strand and at a side facing away from the link chain strands a connection member for a load, wherein the connection locations are arranged at the same height with respect to a load direction.

10. The lifting mechanism system according to claim 9, wherein the connection portion comprises a load hook which is preferably rotatably supported about an axis parallel with the load direction on the stop apparatus.
